(19) United States
(12) Patent Application Publication
(10) Pub. No.: US 2014/0123122 A1
(43) Pub. Date: May 1, 2014

(54) System and method for virtual machine offline patching without mount the virtual disk

(71) Applicant: HCL Technologies Limited, Chennai (IN)

(72) Inventors: Subramanya Uma Maheswara Prasad Dhanyamraju, Hyderabad (IN); Arvind Kumar Maurya, Noida (IN); Prashant Agarwal, Noida (IN); Sekhar Ramaraju Venkata Subramanya, Hyderabad (IN)

(73) Assignee: HCL Technologies Limited, Chennai (IN)

(21) Appl. No.: 13/950,293

(22) Filed: Jul. 25, 2013

(30) Foreign Application Priority Data
Oct. 31, 2012 (IN) 4533/CHE/2012

(51) Int. Cl. G06F 9/445; G06F 9/455

(52) U.S. Cl. CPC G06F 8/65; G06F 9/455
USPC 717/168

(57) ABSTRACT

A system and method for patching offline virtual machine (VM) without mounting virtual hard disks is disclosed. The system directly updates the virtual hard disks attached to a virtual machine by reading, writing or updating the raw bytes of virtual hard disk files. The system applies patch to offline VM that supports multiple vendors virtual disk formats, multiple VM guest OS and multiple file system format by updating the raw sectors of the virtual disk.

### PRIORITY DETAILS

The present application is based on, and claims priority from, Indian Application Number 4533/CHE/2012, filed on 31Oct., 2012, the disclosure of which is hereby incorporated by reference herein.

### TECHNICAL FIELD

The embodiments herein relate to updating a virtual machine (VM) and more particularly to updating the VM in offline without mounting virtual hard disks.

### BACKGROUND OF EMBODIMENT

Virtualization as a technology aims to interpolate a layer between the hardware platform and operating system and executing applications. Virtualization allows users to consolidate multiple physical machines into one physical machine by having one physical machine to support multiple virtual machines. It is proven that virtualization is useful for those end users requiring separate computing environments for different types of applications while in fact only deploying a single hardware platform.

Virtual Machine (VM) is a software implementation of a computer system that emulates the hardware components of hardware system in which an Operating System (OS) can be installed. The virtual machine emulates a physical computing environment, but requests for CPU, memory, hard disk, network and other hardware resources are managed by a virtualization layer which translates these requests to the underlying physical hardware. VMs are created within a virtualization layer, such as a hypervisor or a virtualization platform that runs on a Physical machine. The Physical machine is called Host and Virtual machine as Guest. The installed OS and software components will be stored in a disk file called Virtual Hard Disk. Different vendors have their own disk formats to store the information in Virtual Hard Disk files.

As Virtual Machine has Guest OS or software applications/components installed on it, the Guest OS includes an operating system, one or more user applications, and other various software constructs (software constructs, collectively). Each software construct of the VM may from time to time require an update in the form of a patch or the like released by respective software vendors. Virtual machines are to be patched similar to physical machines in order to keep them secure and updated from security risks. If VM is online, it would get patched from traditional means.

Existing system brings the VM to online and applies patches on it. Also, existing system apply the patch to the VM by mounting a virtual hard disk.

In light of above discussion, a method and system that applies patch or updates to the VM when it is offline and not mounting virtual hard disk is appreciated.

### SUMMARY OF EMBODIMENT

Accordingly the embodiment provides a system for patching offline virtual machine (VM) without mounting virtual hard disks, wherein the system comprises a physical machine, an application, a VM offline patching module, a patch repository, VM library, wherein the VM offline patching module comprises a patch library module and a VM updater module, further the system is configured to extract patch contents from the patch repository, store the extracted patch contents in a location, read disk descriptor of virtual disk file in the offline VM, extract operating system (OS) information from the disk descriptor, provide the extracted OS information to the offline VM updater module and update the offline VM after populating data structures of the OS.

Accordingly the embodiment provides a method for patching offline virtual machine (VM) without mounting virtual hard disks, wherein the method comprises extracting patch contents from a patch repository, storing the extracted patch contents in a location, reading disk descriptor of virtual disk file in the offline VM, extracting operating system (OS) information from the disk descriptor, providing the extracted OS information and updating the offline VM after populating data structures of the OS.

### BRIEF DESCRIPTION OF THE FIGURES

The embodiments herein will be better understood from the following detailed description with reference to the drawings, in which:

FIG. 1 illustrates a block diagram of the overall system, according to embodiments disclosed herein;

FIG. 2 illustrates components in the patch library module, according to embodiments disclosed herein; and

FIG. 3 illustrates components in the VM updater module, according to embodiments disclosed herein.

### DETAILED DESCRIPTION OF EMBODIMENT

The embodiments herein and the various features and details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and a system for applying patch or updates to the VM during offline and without mounting the virtual hard disk. The system directly updates the virtual hard disks attached to a virtual machine by reading, writing or updating the raw bytes or sectors of virtual hard disk files. The system applies patch to offline VM that supports multiple vendors virtual disk formats, multiple VM guest OS and multiple file system format by updating the raw sectors of the virtual disk.

In an embodiment, the guest operating system (OS) can be Windows, UNIX, Linux, Ubuntu, other UNIX like operating systems and so on.

In an embodiment, the file system format can be New Technology File System (NTFS), File Allocation Table (FAT), FAT 32, extended file system (EXT) 2/3 and the like.

In an embodiment, patch can be a packed file that comprises executable files, binaries, documentation, and metadata file and so on.

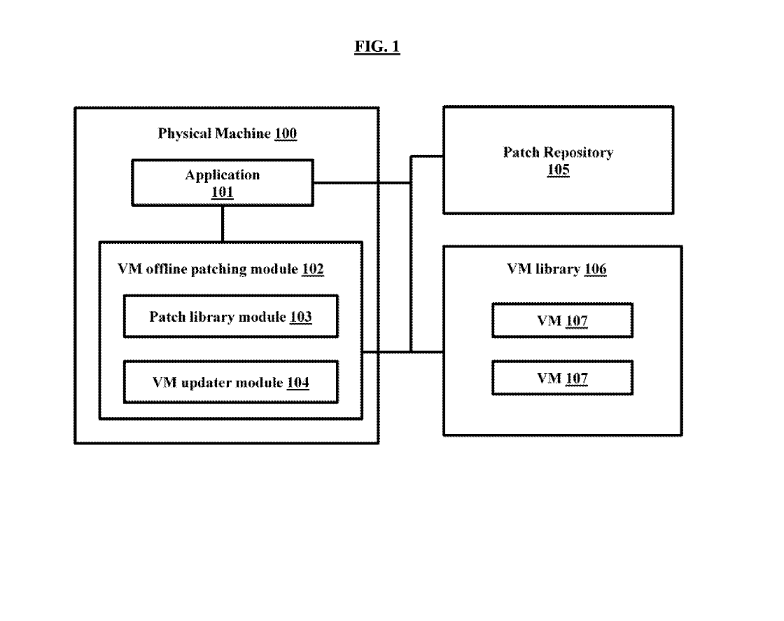

Referring now to the drawings, and more particularly to FIGS. 1 through 3, where similar reference characters denote corresponding features consistently throughout the figures, there are shown embodiments.

FIG. 1 illustrates a block diagram of the overall system, according to embodiments disclosed herein. As depicted in the figure, a physical machine 100 comprises any patch updater application 101 that has the requirement to update the offline virtual machine. In an embodiment, the physical machine (a physical box or physical computer) is a hardware-based device, such as a personal computer. The physical machine 100 comprises a VM offline patching module 102. The VM offline patching module 102 comprises a patch library module 103 and a VM updater module 104. The physical machine 100 is connected with a patch repository 105 which stores all the patches. Further, the physical machine 100 is connected to a VM library 106. The VM library 106 comprises one or more virtual machines (VM) 107. In an embodiment, VM library 106 can be storage medium that comprise one or more VMs or it can be a Virtualization server such as ESX, Microsoft Hyper-v server, XEN and so on.

The application 101 is able to access the VM library 106 and Patch repository 105 to select a VM 107 that needs to be patched with selected patches. The application 101 passes the VM 107 and Patch information to VM offline patching module 102. Normally, when a patch file is executed, the contents of the machine where the patch is executed will be updated with latest components and updates. However, when the VM is not in running state (offline) and patching application 101 is running on a physical machine 100. Hence, the patch library 103 provides the functionality to extract and read the contents of the metadata file in the patch.

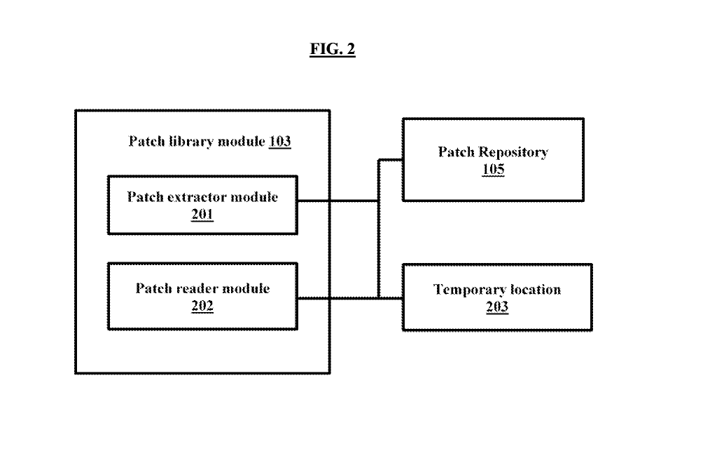

FIG. 2 illustrates components in the patch library module, according to embodiments disclosed herein. The figure depicts the components in the patch library module 103 such as a patch extractor module 201 and a patch reader module 202. Further the components in the patch library module 103 are connected to the patch repository 105 and a temporary location 203. In an embodiment, temporary location 203 can be a directory on the physical machine 100, memory of the physical machine 100.

The patch extractor module 201 extracts patch contents to the temporary location 203. The patch reader module 202 reads patch metadata file from the temporary location 203 and provides the list of changes needs to carry out on the offline VM 107.

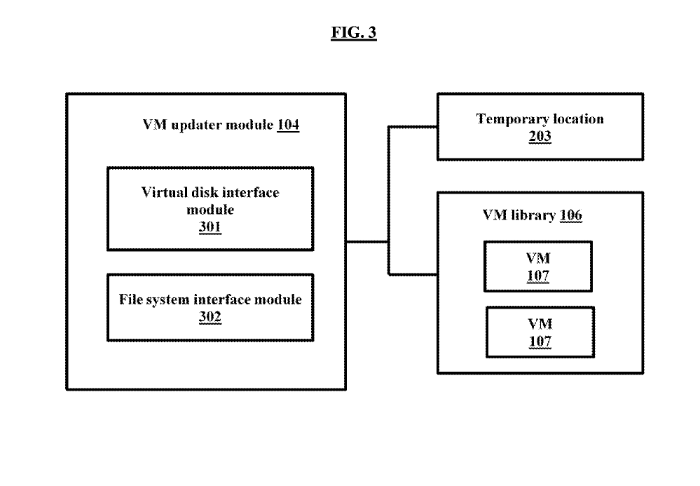

FIG. 3 illustrates components in the VM updater module, according to embodiments disclosed herein. The VM updater module 104 comprises a virtual disk interface module 301, a file system interface module 302. The VM updater module 104 is connected with the temporary location 203 and VM library 106. VM offline patching module 102 uses VM updater module 104 to update VM 107 with selected patch. The virtual disk interface module 301 in the VM updater module 104 interacts with virtual disks. In an embodiment, the virtual disks can be Virtual Machine Disk (VMDK), Virtual Hard Disk (VHD) and Open Virtualization Format (OVF) of multiple vendors like Microsoft, VMware and Citirx.

The Virtual Disk interface module 301 reads disk descriptor section of virtual disk file as given in vendor disk format specifications. From the virtual disk description, virtual disk interface module 301 extracts or calculates Operating System (OS) specific information like address of Boot Sector, Operating System starting location, and file system information (for example sector size, number of sectors per cluster, address of Master File Table and record size of the Master File Table (MFT) for Windows OS).

The virtual disk interface module 301 also loads free or used bitmap information tables for allocation or de-allocation of data blocks. Then virtual disk interface module 301 provides extracted information to the file system interface module 302 to parse and populate OS data structures contained in the Virtual Hard Disk.

After the file system interface module 302 loads all the data structures, the VM offline patching module 102 starts patching or updating one or multiple VM 107 in the VM library 106. The VM offline patching module 102 retrieves file system changes that need to carry on in VM 107 from patch reader module 202. The same information will be provided to file system interface module 302. On receiving file system commands the file system interface module 302 will modify or update file system structures to perform given operation.

When a new file needs to added, then the file system interface module 302 first looks for vacant location from file allocation bitmaps (like Block Group Bitmap and Inode Bitmap, MFT bitmap) allocates a block hard disk space and marks it as used. After that file system interface 302 reads file contents from the temporary location 203 and updates allocated sectors or inode data blocks with data.

When a file needs to be deleted, the file system interface module 302 updates marks bitmap records as free. Once the file system changes are completed, the VM offline patching module 102 retrieves required configuration changes from patch reader module 202 and inform the file system interface module 302 to perform the same.

Once all changes are completed, the VM offline patching module 102 instructs the VM updater module 104 to save the changes. Using virtual disk interface module 301, the VM updater module 104 saves back the virtual disk file changes back on to the disk.

The embodiments disclosed herein can be implemented through at least one software program running on at least one hardware device and performing network management functions to control the elements. The elements shown in FIGS. 1 and 3 include blocks which can be at least one of a hardware device, or a combination of hardware device and software module.

For example, the method and system is implemented for updating fixed size VMware hard disk image file (VMDK) located on the physical machine. The VMware hard disk image file was pre-installed with Windows XP operating system. Initially, the virtual hard disk interface module reads disk descriptor section of VMware virtual disk file as given in VMware disk format specifications. From the virtual disk description, virtual disk interface extracts or calculates windows OS specific information like address of boot sector, sector size, number of sectors per cluster, OS starting sector number, address of MFT and record size of the MFT. Then virtual disk interface module provides extracted information to file system interface module to parse and populate NTFS data structures contained in the virtual hard disk.

Once file system interface module loads all the data structures, VM offline patching module starts patching or updating VM. The VM offline patching module retrieves file system changes that needs to carry on VM from patch reader. The same information will be provided to file system interface module. On receiving file system commands, the file system interface module will modify or update MFT structure to perform given operation.

When a new file needs to added, the file system interface module first looks for vacant MFT record. On finding a free MFT record, the file system interface marks the MFT record as allocated and fills NTFS defined attributes of the file and saves back the MFT record to virtual disk file.

When writing the data of the new file, the file system interface module loads MFT bitmap record and finds free sectors, allocates them for file and updates bitmap record about allocation. After that file system interface reads file contents from temporary location and updates allocated sectors with data.

When deleting a file, the file system interface module updates marks bitmap record and MFT record as free. Once the file system changes are done, VM offline patching module retrieves required registry changes from patch reader module and informs the file system interface module to perform the same operation. File system interface module retrieves registry files data by parsing MFT and performs the registry operations.

Once all changes are done, VM offline patching module instructs the VM updater module to save the changes. Using virtual disk interfaces, VM updater module saves back the virtual disk file changes back on to the disk.

The embodiment disclosed herein specifies a method and system for applying a patch on the offline VM by updating raw sectors of VM hard disk image file without mounting. The system eliminates the process of mounting the image/disk and supports multiple cloud platform vendors virtual disk formats. The system can be integrated in enterprise applications and security products to update virus file updates.

Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A system for patching offline virtual machine (VM) without mounting virtual hard disks, wherein said system comprises:
a physical machine,
an application,
a VM offline patching module,
a patch repository,
VM library,
wherein said VM offline patching module comprises a patch library module and a VM updater module, further said system is configured to:
extract patch contents from said patch repository;
store said extracted patch contents in a location;
read disk descriptor of virtual disk file in said offline VM;
extract operating system (OS) information from said disk descriptor;
provide said extracted OS information to said offline VM updater module; and
update said offline VM after populating data structures of said OS.

2. The system as in claim 1, wherein said system is configured to extract said patch contents using a patch extractor module within a patch library module, further said system is configured to read said extracted patch contents from said location using a patch reader module within said patch library module.

3. The system as in claim 2, wherein said patch reader module is configured to read metadata file from said patch contents stored in said patch repository.

4. The system as in claim 3, wherein said patch reader module is configured to provide list of changes to be performed on said offline VM, after reading said metadata file from said patch contents.

5. The system as in claim 1, wherein said system is configured to read said disk descriptor of said virtual disk file using a virtual disk interface module.

6. The system as in claim 5, wherein said virtual disk interface module is configured to read said operating system (OS) information, wherein said OS information comprises at least one of: address of boot sector, operating system starting location, file system information, further said file system information comprises at least one of: sector size, number of sectors per cluster, address of master file table and record size of said master file table.

7. The system as in claim 1, wherein said system is configured to extract said OS information by said virtual disk interface module.

8. The system as in claim 1, wherein said system is configured to update said VM by said VM updater module.

9. The system as in claim 1, wherein said VM offline patching module is configured to retrieve file system changes to be performed on said offline VM from said patch reader module.

10. The system as in claim 9, wherein said VM offline patching module is configured to provide said retrieved file system changes to said file system interface module, further said file system interface module is configured to perform at least one of: add, delete, update, and modify said file system structures.

11. The system as in claim 10, wherein said file system interface module is configured to search for a vacant location from file allocation bitmaps, wherein said file allocation bitmap comprises at least one of: block group bitmap, inode bitmap, and MFT bit map.

12. The system as in claim 1, wherein said system is configured to update said offline VM with at least one of: Virtual Machine Disk (VMDK), Virtual Hard Disk (VHD), Open Virtualization Format (OVF) virtual hard disk formats.

13. A method for patching offline virtual machine (VM) without mounting virtual hard disks, wherein said method comprises:
extracting patch contents from a patch repository;
storing said extracted patch contents in a location;
reading disk descriptor of virtual disk file in said offline VM;
extracting operating system (OS) information from said disk descriptor;
providing said extracted OS information; and
updating said offline VM after populating data structures of said OS.
